(19) United States
(12) Patent Application Publication
(10) Pub. No.: US 2015/0251917 A1
(43) Pub. Date: Sep. 10, 2015

(54) METHOD OF PATTERNING PILLARS

(71) Applicant: Qualcomm MEMS Technologies, Inc., San Diego, CA (US)

(72) Inventors: Brandon John Hong, San Clemente, CA (US); Jian Ma, Carlsbad, CA (US); John Hyunchul Hong, San Clemente, CA (US); Bing Wen, Poway, CA (US); Tallis Young Chang, San Diego, CA (US)

(21) Appl. No.: 14/301,192

(22) Filed: Jun. 10, 2014

Related U.S. Application Data
(60) Provisional application No. 61/893,820, filed on Oct. 21, 2013.

(51) Int. Cl. C01B 33/113; G02B 5/00

(52) U.S. Cl. CPC C01B 33/113; G02B 5/00

(57) ABSTRACT

The disclosed technology relates to methods of patterning elongated structures. In one aspect, a method of forming pillars includes providing a substrate and providing a plurality of beads on a surface of the substrate. Regions of the surface without a directly overlying bead are exposed. The method additionally includes selectively etching the exposed regions of the substrate between the beads such that a plurality of pillars is formed under areas masked by the beads. Selectively etching completely removes at least some of the beads. The pillars that are not covered by beads are etched, thereby leaving some pillars taller than others, with the pillar height pending on the amount of time a pillar was left exposed to etchant by a removed bead.

### CROSS REFERENCE TO RELATED APPLICATIONS

This application claims priority under 35 U.S.C. §119(e) to U.S. provisional patent application 61/893,820 filed on Oct. 21, 2013, the content of which is incorporated herein by reference in its entirety.

### TECHNICAL FIELD

This disclosure generally relates to illumination devices. More particularly this disclosure relates to methods of forming pillars, such as optically transmissive pillars having different heights.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Display devices can have various optically-active layers that modify the properties of an image produced by the device. For example, the layers can diffuse light or otherwise alter the dispersion of light propagating to, or away from, display elements. In some cases, these layers can be composed of exceptionally small structures that may be difficult to form. Consequently, there is a need for methods of forming small, optically-active structures.

### SUMMARY

In one aspect, a method of forming pillars includes providing a substrate and providing a plurality of beads on a surface of the substrate, where regions of the surface where the beads do not contact each other are exposed. The method additionally includes selectively etching the exposed regions of the substrate between the beads such that a plurality of pillars is formed under areas masked by the beads, where selectively etching completely removes at least some of the beads. In some implementations, the beads can be substantially spherical.

In another aspect, a method for forming pillars includes providing a substrate and providing an etch mask on the surface of the substrate. The method additionally includes providing the etch mask which having a plurality of islands of masking material, where some of the islands have different widths than others of the island. The method further includes etching the substrate through the etch mask to form a plurality of pillars. In some implementations, the islands can be worn away over the course of the etch to expose the pillars at different times. The pillars can be etched for different durations to form pillars of different heights.

### BRIEF DESCRIPTION OF THE DRAWINGS

FIGS. 1A-1B are schematic cross-sectional illustrations of the formation of a pillar structure at two different stages of fabrication according to some implementations.

FIGS. 2A-2E are schematic cross-sectional illustrations of pillar structures having distributed heights at various stages of fabrication according to some implementations.

FIG. 3 is a schematic cross-sectional illustration of a portion of a display device according to some implementations.

FIG. 4 is an isometric view illustration depicting two adjacent interferometric modulator (IMOD) display elements in a series or array of display elements of an IMOD display device.

FIGS. 5A and 5B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Structures that are elongated substantially along a direction can find many uses in electronic and optical devices. For example, elongated structures, such as pillars, that are optically transmissive (for example, optically transparent) can be used to form light diffusers in display devices. The light diffusers can be configured to transmit light, e.g., visible light from a first end of pillars to a second end, where the light exits. In some implementations, the light on the first end is from a light source (for example, ambient light, or light from an artificial light emitter, such as a light emitting diode) and the light exiting the second end can propagate to the display elements to illuminate the display. Where the display elements are reflective, the reflected light may again propagate through the diffuser. When light exits the diffuser, it advantageously may be diffused by the diffuser, which can provide benefits for increasing viewing angles and/or improving uniformity in image properties as viewed from different angles. Such diffusion may be achieved using pillars of different heights and, in some implementations, the pillars may have submicron widths.

Conventional photolithography, which involves patterning a mask layer and etching exposed areas between mask features can be used for fabricating some elongated structures, such as pillars having relatively uniform dimensions, for example, uniform heights. For fabricating elongated structures having nonuniform heights, gray-tone lithography or electron-beam lithography has been contemplated. In these approaches, different regions of a photoresist are exposed to different levels of light or electrons, which results in different removal rate of the photoresist of the different regions. As a result, different regions of the substrate material below the photoresist can be exposed to an etchant at different points in time, such that the substrate regions where the photoresist is removed earlier in time have elongated structures whose heights are shorter compared to substrate regions where the photoresist is removed later in time. However, gray-tone lithography can be limited to patterning elongated structures having relatively large lateral dimensions. In addition, electron beam lithography can be prohibitively expensive for patterning large areas.

In some implementations, patterning processes for fabricating elongated structures are disclosed. The patterning process may utilize mask structures formed by spaced-apart islands of masking material having different widths and heights. In some implementations, the islands include substantially-spherical structures or beads. A substrate under the mask structures is etched and the islands of material are worn away at different times, depending on the size (for example, height and width) of the islands. Thus, the islands both pattern the elongated structures and expose the underlying elongated structures to etchant at different times, thereby forming elongated structures of different heights. In some implementations, the patterning process is self-aligned and/or may form sub-micron sized features. As used herein, self-aligned patterning technologies refer to patterning technologies that do not require a photolithography reticle to pattern or trim the mask structures used in defining the elongated structures. In some implementations, the islands, which can include beads, are deposited on the substrate and used as masking structures to etch and pattern the elongated structures.

Particular implementations of the subject matter described in this disclosure can be implemented to realize one or more of the following potential advantages. For example, sub-micron sized, vertically-elongated structures, such as pillars, may be formed without utilizing expensive lithographic patterning processes such as electron-beam lithography. Instead, less expensive self-patterning processes may be utilized for forming the vertically-elongated structures that are not patterned by lithography.

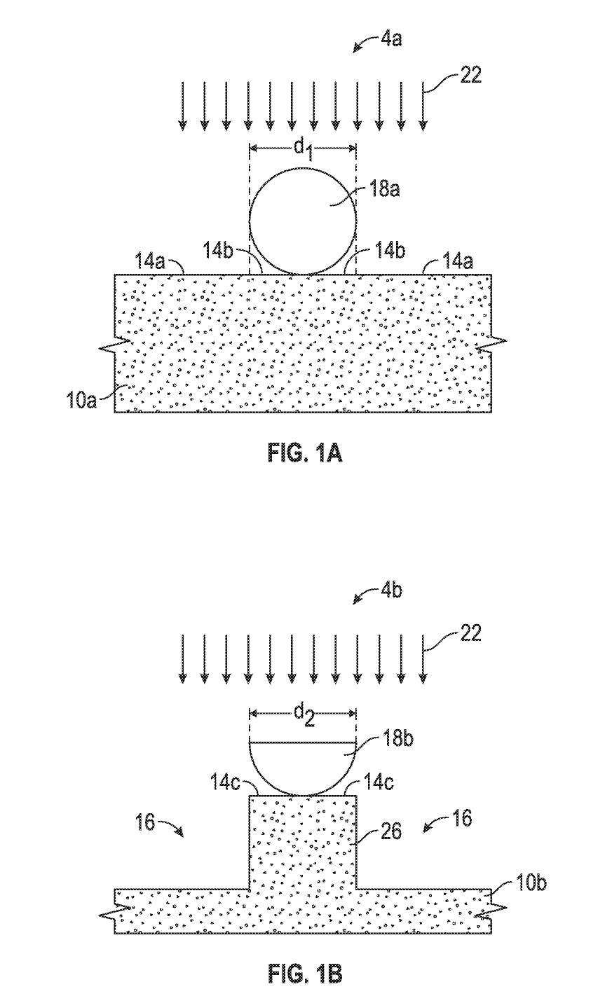

FIGS. 1A-1B are schematic cross-sectional illustrations of the formation of a pillar structure at two different stages of fabrication according to some implementations.

FIG. 1A schematically illustrates an intermediate structure 4a at a fabrication stage for a pillar, according to some implementations. The method includes providing a substrate 10a and providing a plurality of beads 18a (only one bead shown for clarity) on a surface of the substrate 10a. The beads 18a may be rounded and, in some implementations, may be substantially spherical in shape. The method of patterning the pillar further may include using the beads 18a as a self-patterned mask to selectively etch exposed surface regions 14a of the substrate 10a that are exposed to etchants 22, while protecting unexposed surface regions 14b of the substrate 10a from being exposed to the etchants 22. As used herein, exposed surface regions refer to the regions where beads do not directly overlap the surface of the substrate 10a when viewed in a line of sight perpendicular to the surface of the substrate 10a. It will be appreciated that regions may be considered exposed if those regions are visible, as seen in a top-down view, even if the beads do not contact the surface of the substrate 10a, as indicated by the region within the dotted lines.

FIG. 1B schematically illustrates an intermediate structure 4b at another fabrication stage of the pillar, according to some implementations. The intermediate device structure 4b can represent an intermediate device structure 4a of FIG. 1A after exposed regions 14a have been selectively etched by the etchants 22. The substrate material under unexposed surface regions 14c that are protected from the etchants 22 can become a pillar 26 surrounded by trenches 16. In implementations where the initial shape of the bead 18a in FIG. 1A is substantially spherical in shape, the resulting pillar 26 can have a substantially cylindrical shape.

In some implementations, the bead 18a in FIG. 1A can remain intact during the etching process such that the shape and size of the bead 18a remains relatively unchanged. In these implementations, an initial lateral dimension d₁ of the bead 18a at a beginning stage of the etching process and a final lateral dimension d₂ of the bead 18b at a later stage of the etching process can be substantially similar.

In some other implementations, the bead 18a in FIG. 1A can become substantially etched both laterally and vertically, to form a partially etched bead 18b, as schematically shown in FIG. 1B. In these implementations, an initial dimension d₁ of the bead 18a at a beginning stage of the etching process and a final lateral dimension d₂ of the bead 18b at a later stage of the etching process can be substantially different, with d₁ larger than d₂. In some implementations, as discussed herein, d₂ may be reduced to zero and the bead 18b may be completely removed over the course of an etch of the substrate 10a.

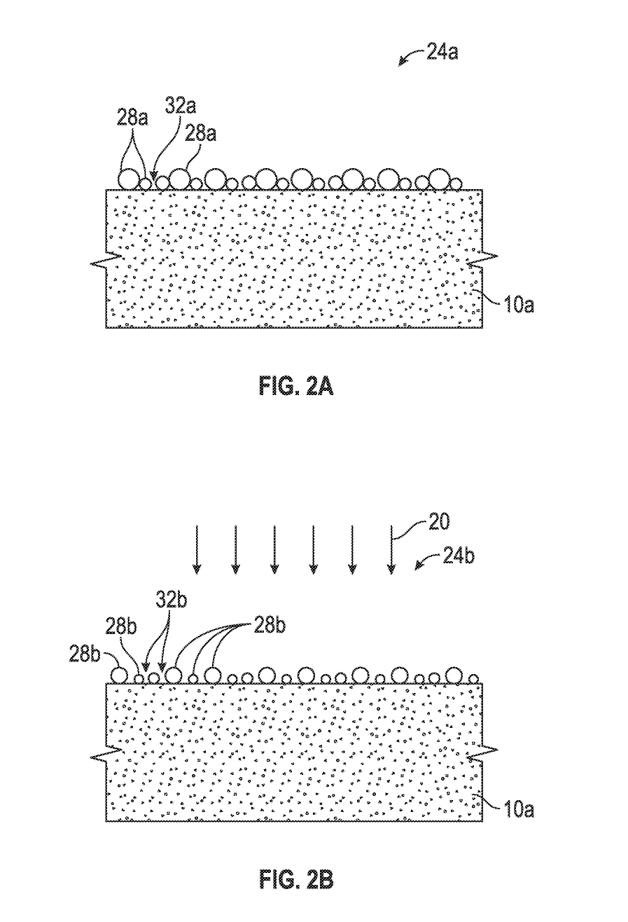

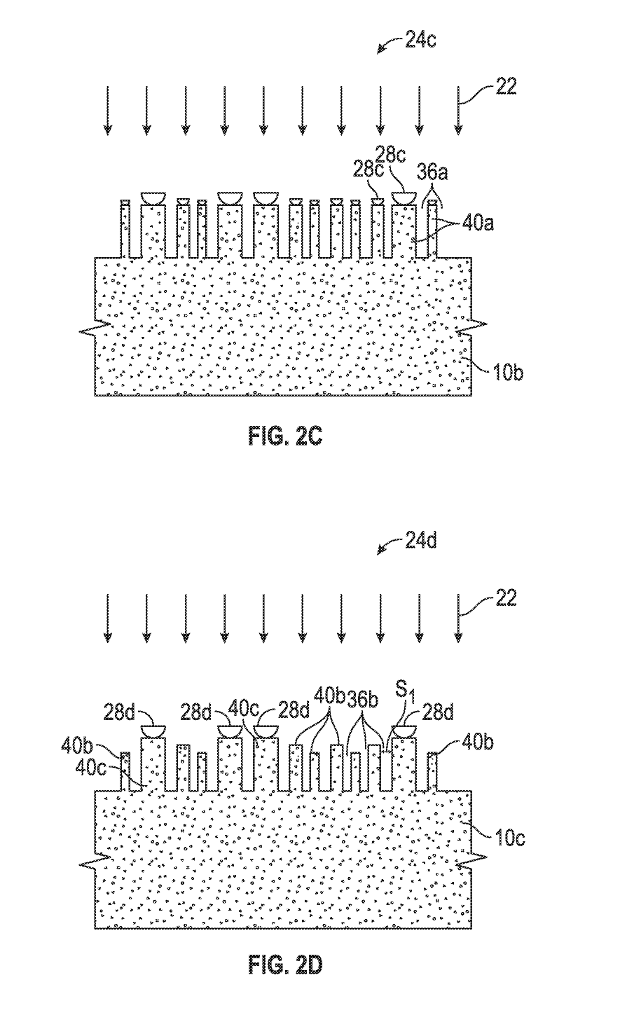

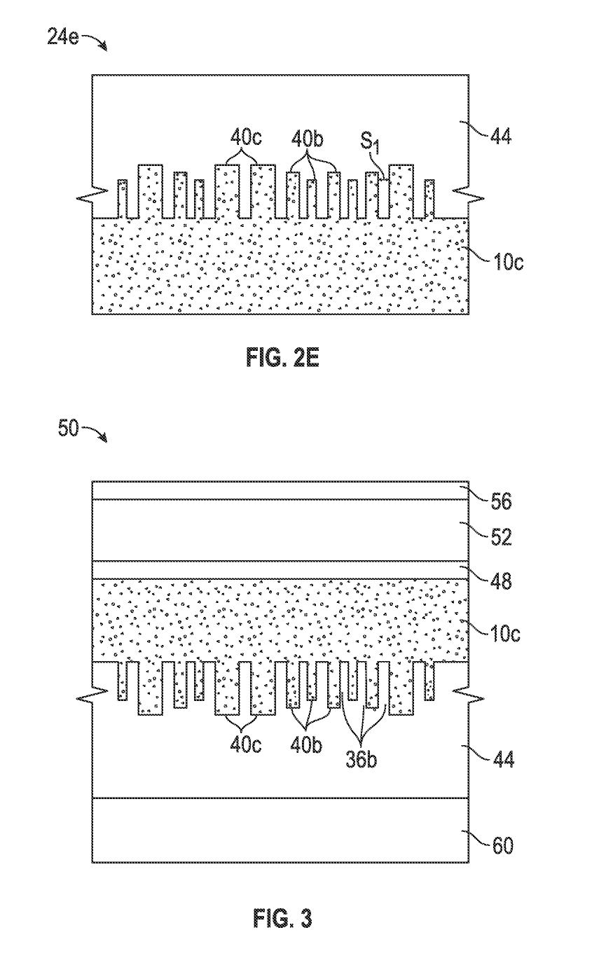

The process of forming the pillar 26 according to some implementations is described in greater detail with respect to FIGS. 2A-2E. FIGS. 2A-2E are schematic illustrations of a method of fabricating pillar structures having distributed heights at various stages of fabrication according to some implementations.

FIG. 2A shows an intermediate structure 24a at a stage of fabrication of the pillars. FIG. 2A illustrates a stage in a method of fabricating the pillar structures having distributed heights, which includes providing a substrate 10a and providing a plurality of beads 28a on a surface of the substrate 10a.

Providing the substrate 10a includes providing a suitable substrate material that can form at least a part of a final structure, or that can be further processed to form at least a part of a final structure. In some implementations, where the final structure is an optically transmissive structure, the substrate 10a can include an optically transmissive substrate material such as, for example, SiO₂ or glass. In some other implementations, the substrate 10a can include a material that can be further processed to form an optically transmissive substrate material such as, for example, silicon (such as amorphous silicon), which can be oxidized to form an optically transparent SiO₂. In some other implementations, other optically transmissive substrate materials can be used, such as metal oxides or nitrides, e.g., TiOₓ, ZrOₓ, and SiNₓ, among other materials. In addition, the substrate 10a may include one or more layers of material. For example, in some implementations, the substrate 10a may include a support structure (which may be formed of optically transmissive material) over which a layer of amorphous silicon has been deposited. The layer may extend over all or a limited portion of the support structure.

The substrate material can be deposited on a support structure using a suitable deposition technique. In some implementations, providing the substrate 10a can include sputter depositing the substrate material on the support structure. In some other implementations, providing the substrate 10a can include depositing by other means, such as chemical vapor deposition, epitaxy, and evaporation, among others.

Still referring to FIG. 2A, the beads 28a can be provided on the surface of the substrate 10a using any suitable technique for providing the beads 18a. In some implementations, a slurry having the beads 28a can be prepared in a fluid medium. A suitable fluid medium can be chosen such that the slurry has certain desirable characteristics such as, for example, a certain viscosity and anti-agglomeration characteristics to keep the beads 28a separated.

In some implementations, the slurry of beads 28a can then be spin-coated on the surface of the substrate 10a using a spin coater. The spin coating process can, for example, include multiple cycles for spreading the beads, and can further spin away excess beads to leave a monolayer of beads. As used herein, a monolayer refers to a layer of beads having an average number of contacts the beads make with each other exceeding one, without significant fraction of beads (e.g., less than about 2.5%, or less than about 1%) being stacked on top of one another. In some implementations, beads having a substantially spherical shape can facilitate close packing and settling of the beads into a monolayer. In some other implementations, the beads can be deposited directly on the surface, for example by spraying process or by an aerosol process.

It will be appreciated that while the beads 28a in FIG. 2A are depicted as having spherical shapes that are symmetric and regular, the beads 28a can have any shape suitable for blocking etchants later in the process to prevent etching of portions of the substrate 10a to form pillars. For example, the beads 28a can have substantially spherical shapes and/or oval or polygonal cross-sectional shapes.

In some implementations, the composition of the beads 28a can be chosen based on the material and the pattern of the final structure. In one aspect, the ability for both the beads 28a and the substrate 10a to be etched using the same etchant, and the etch selectivity between the beads 28a and the substrate 10a for the same etchant can be a factor in choosing the composition of the beads 28a. In some implementations, the beads 28 include a polymeric material, which can have relatively high etch selectivity against substrates such as silicon or silicon dioxide under certain etching conditions and chemistries. For example, a suitable polymeric material can be based on materials such as polystyrene, poly(methyl methacrylate)(PMMA), poly(lactic-co-glycolic acid)(PLGA), and polycaprolacton (PCL), among others. In other implementations, the beads 28a include a dielectric material, such as silicon dioxide, silicon nitride, zinc oxide, and aluminum oxide, among others. In yet other implementations, the beads 28a include a semiconductor or a metallic material, such as silicon, germanium, gold, silver, copper, cadmium selenide (CdSe), and cadium sufide (CdS), among others. In some implementations, both the beads 28a and the substrate 10a can be etched with the same etchant, and the relative rates that the beads 28a and the substrate 10a are etched can be selected (by the selection of materials for the beads 28a and the substrate 10a and/or the selection of the etch chemistry and etch parameters) to form pillars 40a (FIG. 2C) of a desired height. For example, an etch that etches the substrate 10a at a significantly higher rate than the beads 28a may be used to form taller pillars 40a compared to an etch that etches the substrate 10a at a correspondingly lower etch rate.

In some implementations, the beads 28a advantageously have a predetermined distribution of sizes. As discussed above, in some implementations, the beads 28a can have a desired distribution of sizes such that different sized beads have different “wear out” times, which can be advantageous in fabricating pillars having a distribution of heights. In some implementations, within a population of beads (e.g., 1 million beads), the beads have a range of maximum lateral dimensions (e.g., maximum diameters) of about 200 nm to about 600 nm, about 200 nm to about 500 nm, or about 300 nm to about 400 nm, for the population of beads having a mean of maximum lateral dimensions (e.g., a mean of maximum diameters) between about 200 nm and about 500 nm, or between about 300 nm and about 450 nm, for instance about 400 nm. As used herein, a maximum lateral dimension of a bead corresponds to the largest lateral dimension of the bead when viewed in a cross taken along a direction perpendicular to the surface of the substrate 10a, similar to FIG. 2A. In some implementations, the beads have these dimensions when measured in a rectangular area defined by about 10 mm×10 mm.

In some other implementations, the beads can be formed of two or more different materials, with some beads formed of different material than other beads. This can further accentuate the difference in the wear out times of the beads, since the different materials of different beads can have different wear out rates. In some implementations, the beads 28a can have maximum lateral dimensions that are substantially the same, with different ones of the beads formed of different materials which provide different wear out rates that result in the different beads being completely removed at different times. Such beads can be used to pattern pillars of substantially the same width.

As illustrated in FIG. 2A, in some implementations, at least some of the beads 28a may initially be in contact with other beads 28a at one or more contact points, while other beads 28a may be isolated without being in contact with other beads 28a. Some beads 28a may be separated from the neighboring beads 28a by a gap that leaves exposed regions 32a on the surface of the substrate 10a. The degree of “interconnectedness” of the beads 28a can depend on many factors, such as the size and concentration of the beads in a slurry, charge states of the beads, capillary force exerted by the liquid medium, among others. In particular, it will be appreciated that the degree of uniformity of the size distribution of the beads 28a can be a factor in determining the degree of “interconnectedness” of the beads 28a. For example, for spherical beads, when the distribution of sizes of the beads is relatively narrow, the beads may substantially be arranged in a two-dimensional hexagonally close-packed monolayer of beads, in which an average number of contact points per bead can be close to 6. In contrast, when the distribution of sizes of the beads is relatively wide, an average number of contact points per bead may be lower than 6.0, for instance between about 1 and about 5.9, between about 3.0 and about 5.9, or between about 3.0 and about 5.0.

FIG. 2B shows an intermediate structure 24b at a later stage of fabrication of the pillars, according to some implementations. After depositing the beads 28a, the beads 28a may be subjected to an etch to “shrink” their sizes, such that substantially all of the spherical beads 28b become separated from one another. As discussed above with respect to FIG. 2A, the degree of “interconnectedness” of the beads can depend on the uniformity of the size distribution of the beads 28a (FIG. 2A). In some implementations, when the desired final structures include pillars, it can be advantageous to shrink the beads 28a in FIG. 2A such that substantially all beads 28a become beads 28b that are separated by exposed surface regions 32b of the substrate 10a, as illustrated in FIG. 2B. In one aspect, the separated beads 28b can function as separated islands of masking material. After the beads are shrunk, the intermediate structure 24b of FIG. 2B can have exposed surface regions 32b have can have an average opening size that is larger than that of exposed surface regions 32a of FIG. 2A.

It will be appreciated that any suitable shrinking process can be employed to shrink the beads 28a, including isotropic etching processes using reactants 20. In some implementations, where the spherical beads 28a include a polymeric material, the beads 28a can be ashed using an oxidizing reactant 20 having oxygen and/or sulfur, for example ozone, oxygen radicals, oxygen ions, molecular oxygen, atomic oxygen, sulfur radicals, sulfur ions, molecular sulfur, and atomic sulfur, among others. In other implementations, where the spherical beads 28a include an oxide material, the beads can be etched using acidic reactants 20 that can, for example, have hydrofluoric acid. Depending on the composition of the beads 28a, the reactant 20 can be a gas phase reactant (e.g., oxygen, ozone, etc.) or a liquid phase reactant (e.g., hydrofluoric acid). In some other implementations, the shrinking process may include an anisotropic etching processes. While in the illustrated embodiment of FIG. 2B, the beads 28a are depicted as being shrunk prior to substantially etching the substrate 10a, in other embodiments, the beads 28a are shrunk simultaneously with etching of the substrate 10a.

FIG. 2C shows an intermediate structure 24c at a further stage of fabrication of pillars, according to some implementations. In FIG. 2C exposed surface regions 32b (FIG. 2B) of the substrate 10a between the beads 28c are selectively etched such that a plurality of pillars 40a is formed under areas masked by the beads 28c. The resulting pillars 40a are separate by spaces 36a. Selectively etching, as used herein, refers to an etching process whereby regions having different bulk or surface material compositions are etched at different rates under an etch condition.

In some implementations, selectively etching the exposed regions 32b includes anisotropically etching trenches surrounding the pillars 40a. As used herein, an “anisotropic” etch process refers to an etch process wherein a removal rate of a structure to be etched depends on angles of surfaces of the structure to be etched relative to the direction of the etchant. For example, when a trench structure is etched through a surface of a substrate, an anisotropic etch process can remove the substrate material in the direction normal to the substrate surface (e.g., a bottom surface of a trench) at a substantially faster rate compared to the direction perpendicular to the substrate surface (e.g., sidewalls of a trench). As a result, trenches having high aspect ratios (the ratio between a depth and a width) can be formed, for example trenches having aspect ratios that exceeds about 3, or about 5. The degree of anisotropicity can depend on many factors including, for example, the degree of directionality of the etchant species delivered to a surface being etched. The degree of directionality of the etchant species in turn can depend on factors such as the mean-free-path of the etchant species and the degree of electrostatic bias between the etchant species (which can be charged) and the substrate. The degree of anisotropicity can also depend on, for example, whether certain protective layers are formed on surfaces of the structure that are substantially parallel to the substrate surface, for example, sidewalls of the trenches, either as a part of the etch process or as a separate process. The protective layers can include, for example, polymeric material that can be generated from carbon-based etchant species.

Still referring to FIG. 2C, in some implementations, selectively etching the exposed regions 32b includes anisotropically etching trenches adjacent to and/or surrounding the pillars 40a using a reactive ion etching process using etchants 22. In some implementations, the reactive ion etching process includes alternating cycles. The alternating cycles include, for example, etching cycles and passivation cycles. In implementations where the substrate 10b includes a silicon and/or silicon oxide, the etching cycles can subject the substrate 10b to an etchant 22 including fluorides (for example, SF₆, NF₃, Cl₂, F₂, and/or BCl₂) to remove the silicon and/or silicon oxide from bottom surfaces of the trenches, while the passivation cycles can subject the substrate 10b to an etchant 22 including carbon fluorides (for example, CHF₃, CF₄, C₄F₈, and/or C₂F₆) to form protective layers that can include a fluorocarbon-based polymeric material on sidewalls of the trenches. During the passivation cycle, polymeric fluorocarbons can form on the sidewalls of the pillars 40a, such that the sidewalls are substantially protected from etchants 22 during an etching cycle following a passivation cycle. It will be appreciated that while carbon fluorides can be used to form fluorocarbon-based polymers that protect the sidewalls of the pillars 40a under some circumstances, they can also be as etchants. Such cycles of etching and passivation can advantageously facilitate the formation of high aspect ratio pillars.

It will be appreciated that in the illustrated implementation of FIG. 2C, substantially all beads 28c, while partially etched as discussed in connection with FIG. 1B, remain on the top surfaces of the pillars 40a. As a result, in some implementations, the trenches 36a surrounding the pillars 40a can be relatively uniform in depth, compared to those in FIG. 2D, described below.

FIG. 2D shows an intermediate structure 24d at a yet later stage of fabrication of pillars, according to some implementations. At least some of the beads 28c that remained in FIG. 2C are completely removed. As discussed with respect to FIG. 2A, the initially deposited beads 28a can have a distribution of sizes. In these implementations, subsequently shrunk beads 28b of FIG. 2B as well as partially etched beads 28c of FIG. 2C can also have distributions of sizes. As the partially etched beads 28c of FIG. 2C continue to be etched (“worn out” laterally and/or vertically) by etchants 22, at a point during the etching process certain of the smaller beads 28c are removed altogether, leaving the surfaces of the pillars 40a exposed to etchants 22. The exposed pillars 40b can then start to be etched from the top surfaces, resulting in a partial reduction of the vertical heights of the pillars 40b, while unexposed pillars 40c continue to be protected from the etchants 22 by the remaining beads 28d and do not result in a similar reduction of their vertical heights.

As discussed herein and illustrated in FIG. 2D, in some implementations, by choosing a set of physical parameters in providing and processing the beads, such as, for example, an average size of the beads, a size distribution of the beads, shrinking process parameters, and subsequent selective etch process parameters, certain physical attributes of the pillars 40b and 40c can be obtained.

For example, in some implementations, some of the pillars 40b can be recessed. The amount by which the exposed pillars 40b have top pillar surfaces recessed below an initial surface level of the substrate surface, which can be the surface level of the unexposed pillars 40c, can be controlled by controlling the set of physical parameters.

In addition, in some other implementations, the beads that are completely removed can be beads that initially had relatively smaller dimensions prior to the selective etching, such that the exposed pillars 40b can have pillar widths (or diameters where the pillar is round) that are smaller than pillar widths (or diameters) of unexposed pillars 40c, for example. In some implementations, all beads 28d may ultimately be worn away, and the pillars 40b and 40c may all be subjected to an etch of their top surface for some duration.

In some implementations, the etch selectivity between the beads 28d and the substrate 10c can be advantageously chosen to obtain desired attributes of the pillars 40b and 40c, including widths, width distributions, height and height distributions, among other attributes. The etch selectivity can be measured, for example, by a ratio between an average thickness of the bead material removed and an average thickness of the substrate material removed, when measured in a direction perpendicular to the substrate surface. In some implementations, the etch selectivity can be between about 1:20 and about 1:1, between about 1:10 and about 1:2, or between about 1:6 and 1:3, for instance about 1:4.

Still referring to FIG. 2D, it will be appreciated that, while the pillars 40b and 40c have vertical sidewalls, the pillars can have sloped sidewalls in some implementations. The sloped sidewalls can result, for example, in circumstances where, in addition to being etched vertically, the beads 28d continuously shrinks laterally throughout the selective etch process. In these implementations, the surface area of the substrate 10a masked by a bead 28d continuously shrinks during the selective etch process. The resulting pillar 40b or 40c can have a smaller diameter towards an upper region compared to a lower region such that the sidewalls of the pillar are sloped when viewed in a cross section. In some implementations, the sidewalls of the pillars 40b or 40c can form an angle between about 70 degrees to about 89 degrees or about 70 degrees to about 86 degrees, for instance about 75 degrees, when measured in a cross sectional view between the sidewalls and the planar top surfaces of unexposed pillars 40b and 40c.

It will be further appreciated that, while the pillars 40b and 40c have sharp corners formed by sidewalls and the top surfaces, in some implementations, the pillars 40b and 40c can have substantially rounded corners.

Still referring to FIG. 2D, in some implementations, the pillars 40b and 40c can have a mean diameter between about 0.1 μm and about 0.5 μm, or about 0.2 μm and about 0.5 μm. Also, in some implementations, the pillars 40b and 40c can be spaced apart with substantially random distances between pillars, such that a mean distance between adjacent edges of adjacent pillars (labeled as S₁ in FIG. 2E) is between about 0.1 μm and about 0.5 μm, for instance about 0.4 μm. In some implementations, these pillar distances can be obtained when measured in a rectangular area defined by, e.g., about 10 mm×10 mm, or, e.g., substantially an entire display area.

Still referring to FIG. 2D, in some implementations, where the substrate 10c includes a non-transmissive substrate material that can be further processed to increase the transparency of the substrate material, at least the pillars 40c and 40b may be further processed to increase their optical transparency. For example, in implementations where the substrate 10c includes a silicon-based material, at least the pillars 40b and 40c can be oxidized to form silicon oxide-based pillars 40b and 40c.

Still referring to FIG. 2D, in some implementations, the remaining beads 28d can be removed (not shown) by a suitable process, such as using a lift-off technique or an agitation technique, depending on the nature of the chemical affinity/bonding between the remaining beads 28d and the top surfaces of the pillars 40c. In some other implementations, the substrate etch may be continued until the beads 28d are completely worn away. In some other implementations, any residual beads 28d may be removed by an isotropic or anisotropic etch selective for those beads 28d.

FIG. 2E shows an intermediate structure 24e at a yet later stage of fabrication of pillars, according to some implementations. Spaces 36b between adjacent pillars 40b and 40c can be filled with a gapfill material 44. In some implementations, the gapfill material 44 has a lower refractive index compared to the refractive index of the material of the pillars 40b and 40c. For example, in implementations where the pillars 40b and 40c include silicon dioxide (SiO₂), the gapfill material 44 can include materials such as MgF₂ and low index SOG (spin-on glass).

The spaces 36b can be filled with the gapfill material 44 using any suitable gap-filling technique, including, for example, chemical vapor deposition (CVD), plasma-enhanced chemical vapor deposition (PECVD), high density chemical vapor deposition (HDPCVD), atomic layer deposition (ALD), spin-on-dielectric deposition, and spin coating or slid coating of SOG and polymer, followed by backing and curing, among others.

In some implementation, optically absorptive materials, e.g., carbon, can be mixed into the gapfill material 44 (e.g., SOG and polymer), to form an absorptive cladding.

In some implementations, the surface of the intermediate structure 24e after filling the spaces 36b can be planarized through a chemical mechanical polishing (CMP) process. The planar surface of the structure 24e can facilitate integration of that structure with other structures to form, for example, a display device.

Still referring to FIG. 2E, the pillars 40b and 40c have pillar heights that can be selected to have a certain mean value and a range. For example, in some implementations, a mean height of pillars 40b and 40c can be chosen to be between about 1.5 μm and about 2.0 μm. In addition, in some implementations, the variation in height between the shortest and the tallest pillars may be between about 0 μm and about 0.7*Δn μm, where Δn is a refractive index difference between the pillars 40b and 40c and the gapfill material 44 that can be formed to surround the pillars 40b and 40c after forming the pillars 40b and 40c. In some other implementations, the variations in heights amongst the pillars 40b and 40c can have a range of heights between about 0.1*Δn μm and about 0.6*Δn μm, or about 0.3*Δn μm and about 0.5*Δn μm. By way of an illustrative example only, for a device having a Δn of about 0.3, the pillars 40b and 40c can have a range of heights that can be as high as 0.21 μm (210 nm). In some implementations, these ranges can be measured in a rectangular area defined by, e.g., about 10 mm×10 mm, or e.g., substantially an entire display area. In some implementations, the gapfill material 44 may have a lower refractive index than the pillars 40b and 40c and may function as a cladding layer. The value of Δn together with the refractive index of cladding can determine the numerical aperture or the light acceptance angle of the pillar. In some implementations, the cladding refractive index may be in a range between about 1.38 and about 1.5, and Δn may range between about 0.01 to about 0.3, and about 0.1 to about 0.2. In some other implementations, the cladding can include air having a refractive index of about 1.0. In these implementations, Δn can have a range between about 0.3 (e.g., pillars 40b and 40c including SiO₂) and about 2.5 (e.g., pillars 40b and 40c including TiO₂).

FIG. 3 shows a schematic cross-sectional illustration of a portion of a display device 50 according to some implementations. The display device 50 may be a reflective display device. The display device 50 includes an optical device including pillars 40b and 40c having distributed heights. Spaces 36b between adjacent pillars 40b and 40c can be filled with a gapfill material 44 having a refractive index different from the refractive index of the pillars 40b and 40c. In FIG. 3, orientation of the pillars 40b and 40c and the gapfill material 44 has been flipped with respect to FIG. 2E. In the illustrated implementation, the structure formed by the pillars 40c and 40b and the gapfill material 44 may be a viewing angle controller that is interposed between a light guide panel 52 and display elements 60. In some implementations, the display device 50 can further include cladding layers 48 and 56 formed on either or both sides of the light guide panel 52, which can assist in light propagation along a direction parallel to the top and bottom surfaces of the light guide panel 52. In some implementations, the display device 50 can further include an optional separation (not shown) between a bottom surface of the substrate 10c and the display element 60.

In operation, the device 50 may be configured to couple light into the pillars 40b and 40c, such that the pillars 40b and 40c that are surrounded by the gapfill material 44 can serve as pillar light guides or small optical fibers. Such a structure can accept ambient light, or illumination light from the light guide 52, at a wide range of angles. Light exiting the pillars towards the display elements 60 will exit in a cone of light within an output cone centered about roughly normal to the substrate 10c irrespective of the angle of incidence of the light. This may help to reduce the viewing angle color shift in reflected color from the display element 60 (which may be one or more interferometric modulators) since ambient light or illumination light will be provided to the display elements 60 within a given cone regardless of angle of incidence of that light on the pillars 40b and 40c. For light incident on the optical viewing angle controller after reflection from the display elements 60, the optical viewing angle controller may appear as a diffuser that can also help to increase the range of viewing angles for the display device 50. Hence the optical function of the optical viewing angle controller can be asymmetrical, working to provide light within a given range of angles to the display elements 60 independent of incident angle of light incident upon the optical viewing angle controller while also working to diffuse reflected light from reflective display elements 60. It will be appreciated that the display device 50 can have an array of display elements 60. In some implementations, the display elements 60 are reflective display elements, such as MEMS devices, including interferometric modulators, and the light guide 52 can be part of front light of the display device 50. In some other implementations, the display elements 60 are transmissive and the light guide 52 may be part of a backlight of the display device 50.

It will be appreciated that the device 50 can be formed by attaching various structure to the diffuser formed of gapfill material 44 and pillars 40b and 40c. For example, the light guide structure with the light guide 52 and cladding layers 48 and 56 may be attached to the display elements 60, with the gapfill material 44 including an optically transmissive material. In some other implementations, the pillars 40b and 40c are formed on the same structure which supports the display elements 60 during fabrication of those display elements.

An example of a suitable EMS or MEMS device or apparatus, to which the above described implementations may apply, is a reflective display device (for example, including the display elements 60 (FIG. 3)), as noted above. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

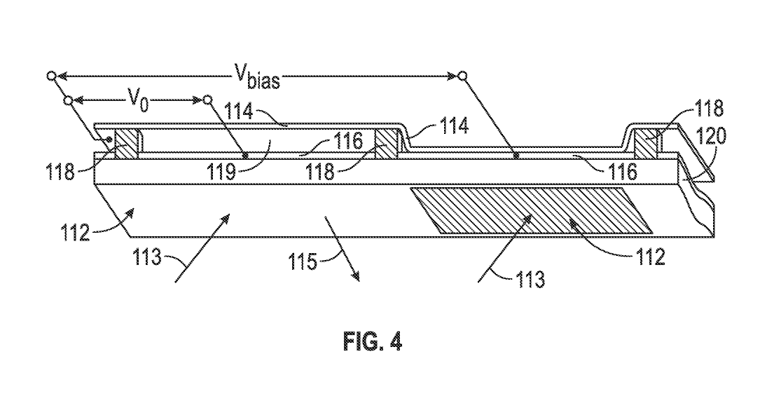

FIG. 4 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 4 includes two adjacent interferometric MEMS display elements in the form of IMOD display elements 112 (which can correspond to the display elements 60 (FIG. 3)). In the display element 112 on the right (as illustrated), the movable reflective layer 114 is illustrated in an actuated position near, adjacent or touching the optical stack 116. The voltage V_{bias} applied across the display element 112 on the right is sufficient to move and also maintain the movable reflective layer 114 in the actuated position. In the display element 112 on the left (as illustrated), a movable reflective layer 114 is illustrated in a relaxed position at a distance (which may be predetermined based on design parameters) from an optical stack 116, which includes a partially reflective layer. The voltage V₀ applied across the display element 112 on the left is insufficient to cause actuation of the movable reflective layer 114 to an actuated position such as that of the display element 112 on the right.

In FIG. 4, the reflective properties of IMOD display elements 112 are generally illustrated with arrows indicating light 113 incident upon the IMOD display elements 112, and light 115 reflecting from the display element 112 on the left. Most of the light 113 incident upon the display elements 112 may be transmitted through the transparent substrate 120, toward the optical stack 116. A portion of the light incident upon the optical stack 116 may be transmitted through the partially reflective layer of the optical stack 116, and a portion will be reflected back through the transparent substrate 120. The portion of light 113 that is transmitted through the optical stack 116 may be reflected from the movable reflective layer 114, back toward (and through) the transparent substrate 120. Interference (constructive and/or destructive) between the light reflected from the partially reflective layer of the optical stack 116 and the light reflected from the movable reflective layer 114 will determine in part the intensity of wavelength(s) of light 115 reflected from the display element 112 on the viewing or substrate side of the device. In some implementations, the transparent substrate 120 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 112 of FIG. 4 and may be supported by a non-transparent substrate.

The optical stack 116 can include a single layer or several layers. The layer(s) can include one or more of an electrode layer, a partially reflective and partially transmissive layer, and a transparent dielectric layer. In some implementations, the optical stack 116 is electrically conductive, partially transparent and partially reflective, and may be fabricated, for example, by depositing one or more of the above layers onto a transparent substrate 120. The electrode layer can be formed from a variety of materials, such as various metals, for example indium tin oxide (ITO). The partially reflective layer can be formed from a variety of materials that are partially reflective, such as various metals (for example, chromium and/or molybdenum), semiconductors, and dielectrics. The partially reflective layer can be formed of one or more layers of materials, and each of the layers can be formed of a single material or a combination of materials. In some implementations, certain portions of the optical stack 116 can include a single semi-transparent thickness of metal or semiconductor which serves as both a partial optical absorber and electrical conductor, while different, electrically more conductive layers or portions (for example, of the optical stack 116 or of other structures of the display element) can serve to bus signals between IMOD display elements. The optical stack 116 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 114, and these strips may form column electrodes in a display device. The movable reflective layer 114 may be formed as a series of parallel strips of a deposited metal layer or layers (orthogonal to the row electrodes of the optical stack 116) to form columns deposited on top of supports, such as the illustrated posts 118, and an intervening sacrificial material located between the posts 118. When the sacrificial material is etched away, a defined gap 119, or optical cavity, can be formed between the movable reflective layer 114 and the optical stack 116. In some implementations, the spacing between posts 118 may be approximately 1-1000 μm, while the gap 119 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 114 remains in a mechanically relaxed state, as illustrated by the display element 112 on the left in FIG. 4, with the gap 119 between the movable reflective layer 114 and optical stack 116. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 114 can deform and move near or against the optical stack 116. A dielectric layer (not shown) within the optical stack 116 may prevent shorting and control the separation distance between the layers 114 and 116, as illustrated by the actuated display element 112 on the right in FIG. 4. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

Implementations of the illumination system described herein can be disposed over the substrate 20 in order to provide front illumination to the IMOD display elements 112.

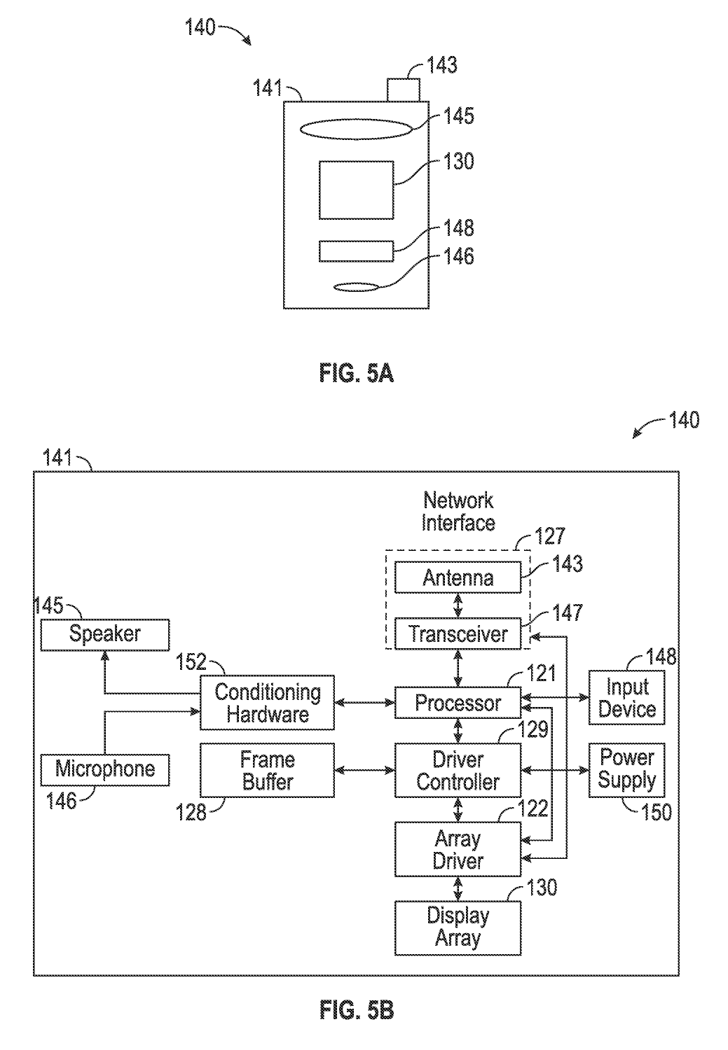

FIGS. 5A and 5B are system block diagrams illustrating a display device 140 that includes a plurality of IMOD display elements (for example, display elements 112). The display device 140 can be, for example, a smart phone, a cellular or mobile telephone. However, the same components of the display device 140 or slight variations thereof are also illustrative of various types of display devices such as televisions, computers, tablets, e-readers, hand-held devices and portable media devices.

The display device 140 includes a housing 141, a display 130, an antenna 143, a speaker 145, an input device 148 and a microphone 146. The housing 141 can be formed from any of a variety of manufacturing processes, including injection molding, and vacuum forming. In addition, the housing 141 may be made from any of a variety of materials, including, but not limited to: plastic, metal, glass, rubber and ceramic, or a combination thereof. The housing 141 can include removable portions (not shown) that may be interchanged with other removable portions of different color, or containing different logos, pictures, or symbols.

The display 130 may be any of a variety of displays, including a bi-stable or analog display, as described herein. The display 130 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 140 are schematically illustrated in FIG. 5A. The display device 140 includes a housing 141 and can include additional components at least partially enclosed therein. For example, the display device 140 includes a network interface 127 that includes an antenna 143 which can be coupled to a transceiver 147. The network interface 127 may be a source for image data that could be displayed on the display device 140. Accordingly, the network interface 127 is one example of an image source module, but the processor 121 and the input device 148 also may serve as an image source module. The transceiver 147 is connected to a processor 121, which is connected to conditioning hardware 152. The conditioning hardware 152 may be configured to condition a signal (such as filter or otherwise manipulate a signal). The conditioning hardware 152 can be connected to a speaker 145 and a microphone 146. The processor 121 also can be connected to an input device 148 and a driver controller 129. The driver controller 129 can be coupled to a frame buffer 128, and to an array driver 122, which in turn can be coupled to a display array 130. One or more elements in the display device 140, including elements not specifically depicted in FIG. 5A, can be configured to function as a memory device and be configured to communicate with the processor 121. In some implementations, a power supply 150 can provide power to substantially all components in the particular display device 140 design.

The network interface 127 includes the antenna 143 and the transceiver 147 so that the display device 140 can communicate with one or more devices over a network. The network interface 127 also may have some processing capabilities to relieve, for example, data processing requirements of the processor 121. The antenna 143 can transmit and receive signals. In some implementations, the antenna 143 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 143 transmits and receives RF signals according to the Bluetooth® standard. In the case of a cellular telephone, the antenna 143 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 147 can pre-process the signals received from the antenna 143 so that they may be received by and further manipulated by the processor 121. The transceiver 147 also can process signals received from the processor 121 so that they may be transmitted from the display device 140 via the antenna 143.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 121 can include a microcontroller, CPU, or logic unit to control operation of the display device 140. The conditioning hardware 152 may include amplifiers and filters for transmitting signals to the speaker 145, and for receiving signals from the microphone 146. The conditioning hardware 152 may be discrete components within the display device 140, or may be incorporated within the processor 121 or other components.

The driver controller 129 can take the raw image data generated by the processor 121 either directly from the processor 121 or from the frame buffer 128 and can re-format the raw image data appropriately for high speed transmission to the array driver 122. In some implementations, the driver controller 129 can re-format the raw image data into a data flow having a raster-like format, such that it has a time order suitable for scanning across the display array 130. Then the driver controller 129 sends the formatted information to the array driver 122. Although a driver controller 129, such as an LCD controller, is often associated with the system processor 121 as a stand-alone Integrated Circuit (IC), such controllers may be implemented in many ways. For example, controllers may be embedded in the processor 121 as hardware, embedded in the processor 121 as software, or fully integrated in hardware with the array driver 122.

The array driver 122 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 129, the array driver 122, and the display array 130 are appropriate for any of the types of displays described herein. For example, the driver controller 129 can be a conventional display controller or a bi-stable display controller (such as an IMOD display element controller). Additionally, the array driver 122 can be a conventional driver or a bi-stable display driver (such as an IMOD display element driver). Moreover, the display array 30 can be a conventional display array or a bi-stable display array (such as a display including an array of IMOD display elements). In some implementations, the driver controller 129 can be integrated with the array driver 122. Such an implementation can be useful in highly integrated systems, for example, mobile phones, portable-electronic devices, watches or small-area displays.

In some implementations, the input device 148 can be configured to allow, for example, a user to control the operation of the display device 140. The input device 148 can include a keypad, such as a QWERTY keyboard or a telephone keypad, a button, a switch, a rocker, a touch-sensitive screen, a touch-sensitive screen integrated with the display array 130, or a pressure- or heat-sensitive membrane. The microphone 146 can be configured as an input device for the display device 140. In some implementations, voice commands through the microphone 46 can be used for controlling operations of the display device 140.

The power supply 150 can include a variety of energy storage devices. For example, the power supply 150 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 150 also can be a renewable energy source, a capacitor, or a solar cell, including a plastic solar cell or solar-cell paint. The power supply 150 also can be configured to receive power from a wall outlet.

In some implementations, control programmability resides in the driver controller 29 which can be located in several places in the electronic display system. In some other implementations, control programmability resides in the array driver 122. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of forming pillars, comprising:
providing a substrate;
providing a plurality of beads on a surface of the substrate, wherein regions of the surface without a directly overlying bead are exposed; and
selectively etching the exposed regions of the substrate between the beads such that a plurality of pillars is formed under areas masked by the beads,
wherein selectively etching completely removes at least some of the beads.

2. The method of claim 1, wherein the beads are substantially spherical.

3. The method of claim 2, wherein providing the beads includes providing the beads having diameters in a range between about 200 nm and about 600 nm.

4. The method of claim 1, further comprising:
shrinking the beads after providing the beads and prior to selectively etching, wherein at least some of the beads contact one another before shrinking, and wherein substantially all of the beads become separated from one another after shrinking.

5. The method of claim 4, wherein the beads include a polymeric material, and wherein shrinking the beads includes ashing the spherical beads using an oxidizing reactant.

6. The method of claim 1, wherein selectively etching removes the at least some of the beads that are completely removed while the exposed regions are being etched, such that a subset of the pillars corresponding to areas masked by the at least some of the beads have top pillar surfaces recessed substantially below an initial surface level of the substrate surface, thereby forming recessed pillars.

7. The method of claim 6, wherein the recessed pillars have pillar diameters smaller than an average diameter of the plurality of pillars.

8. The method of claim 7, wherein the pillars of the plurality of pillars have a difference in pillar heights ranging between about 1 nm and about 900 nm.

9. The method of claim 7, wherein the pillars of the plurality of pillars have a difference in pillar heights ranging between about 1 nm and about 210 nm.

10. The method of claim 1, wherein the substrate includes silicon.

11. The method of claim 10, wherein the beads include silicon dioxide.

12. The method of claim 10, wherein the substrate includes amorphous silicon.

13. The method of claim 10, further comprising oxidizing the pillars to form optically transmissive pillars including silicon dioxide.

14. The method of claim 1, wherein the pillars are spaced apart randomly, wherein a mean distance between a pillar and a closest adjacent pillar is between about 0.1 microns and about 0.5 microns.

15. The method of claim 1, further including filling spaces between adjacent pillars with a dielectric material.

16. The method of claim 15, wherein the dielectric material has a refractive index less than a refractive index of the pillar.

17. A method for forming pillars, comprising:
providing a substrate;
providing an etch mask on the surface of the substrate, the etch mask including a plurality of islands of masking material, wherein some of the islands have different widths than others of the island;
etching the substrate through the etch mask to form a plurality of pillars.

18. The method of claim 17, wherein the islands include at least one contact region between adjacent islands.

19. The method of claim 17, wherein the islands are formed by substantially spherical beads.

20. The method of claim 19, wherein the spherical beads form a monolayer of beads.

21. The method of claim 20, wherein the monolayer of beads is substantially close packed such that the spherical beads include at least four contact regions between adjacent beads.

22. The method of claim 17, wherein the widths of the islands are within a range between about 200 nm and about 600 nm.
